(19) United States
(12) Patent Application Publication
(10) Pub. No.: US 2024/0400028 A1
(43) Pub. Date: Dec. 5, 2024

(54) PNEUMATIC VALVE DEVICE INCLUDING A QUICK RELEASE INSERT

(71) Applicant: ZF CV Systems Europe BV, Brussels (BE)

(72) Inventors: Rafal Bialon, Olawa (PL); Jorge Garcia Moreno, Wroclaw (PL); Pawel Stachowiak, Wroclaw (PL)

(21) Appl. No.: 18/690,829

(22) PCT Filed: Sep. 16, 2021
(86) PCT No.: PCT/EP2021/075430

§ 371 Date: Mar. 11, 2024

(51) Int. Cl. B60T 15/02; B60T 15/52

(52) U.S. Cl. CPC B60T 15/027; B60T 15/52

(57) ABSTRACT

A pneumatic ABS valve device (10) includes: a casing (1) having a supply port (2) for receiving pressurized air; a working port (3) for providing a braking pressure to a brake actuator (9); an exhaust port (4) for a releasing pressurized air from the brake actuator (9); and a flow path (17) defined in the casing (1) and connecting the working port (3) and the supply port (2). A reversibly deformable quick release insert (5) is arranged in the flow path (17) and received in the casing (1) and moves into a blocking position (B) when an exhaust air flow (f2) is provided by the working port (3). The quick release insert deforms in the blocking position (B) to sealingly rest against a sealing surface (28) of the casing (1) thereby blocking the flow path (17), and returns into an undeformed basic position (A) in an unloaded or low-loaded condition.

### FIELD

The present disclosure relates to a pneumatic Anti-lock Braking System (hereinafter referred to as “ABS”) valve device for a pneumatic brake system of a vehicle. More particularly, the pneumatic ABS valve device includes: a casing configured for being in fluid connection to the pneumatic brake, the casing having a supply port for receiving pressurized air; a working port for providing a braking pressure to a brake actuator; an exhaust port for a releasing pressurized air from the brake actuator; and a flow path defined in the casing and connecting the working port and the exhaust port. Additionally, the pneumatic ABS valve device includes a quick release insert being reversibly deformable and at least partly arranged in the flow path, and the quick release insert is moveably received in the casing and configured to move into a blocking position when an exhaust air flow is provided by the working port.

In particular, the present disclosure relates to a pneumatic ABS valve device for a pneumatic brake system of a commercial vehicle.

### BACKGROUND

Vehicles, in particular commercial vehicles, are often equipped with pneumatic brake systems. In pneumatic brake systems of the vehicles in general, an ABS valve device is provided between a brake line, which is pressurized in case of brake action, and the brake actuator.

ABS valve devices are in general switchable into the following positions and enables the following modes: first, an open position for a supply mode or brake mode is provided, for transmitting pressurized air from the brake line via its supply port and its working port to the pneumatic brake. In the open position, the brake pressure in a pneumatic brake actuator can therefore be increased via the brake line. Further, a slow release of the brake pressure is realized via the open ABS valve, the brake line and preferably a relay valve to the brake line, in particular a control relay valve for pressurizing and releasing (bleeding) the brake line. Furthermore, the ABS valve in general enables a pressure holding position, in which the pressurized brake actuator is separated from the brake line for holding the brake pressure in the brake actuator.

Due to legal regulations in some states or regions, for example the USA, a quick exhaust of the brake actuator has to be provided. Thus, known ABS valve devices also enable a quick release of the brake actuator. For the quick release function, a connection between the working port to the exhaust port is provided which enables a quicker bleeding of the brake actuator.

The positions described above can be realized by e.g. two 2/2 way solenoid valves connecting the three ports of the ABS valve device, in particular a first 2/2 way solenoid valve connecting the supply port and the delivery port and a second 2/2 way solenoid valve connecting the delivery port and the quick release outlet.

It is known in the art to realize the quick release by a check valve (non-return valve) provided between the supply port and the working port. Further, the check valve can be bypassed by a throttle to enable the slow pressure release in the open position of the ABS valve device. However, pressure variations in pneumatic systems with long pneumatic lines often take more time and therefore the switching of the ABS valve device between its positions can be undesirably impacted.

In the alternative, a quick release insert configured for selectively blocking the flow path between the supply port and the working port can realize the quick release. US 2021/129820 A1 shows such a quick release insert known in the art for selectively blocking the flow path. The quick release insert is pivoted around a protruding part by pressurized air provided at the working port from a basic position to a blocking position. After quick exhaust of the brake, the quick release insert pivots back into its basic position by gravity.

The known insert allows a sufficient pressure release. However, since the pivoting movement results in an increased failure proneness, the reliability as well as the sealing and blocking effectiveness of the known quick release insert may still be optimized. Further, a slow release of pressurized air has to be implemented by a separate throttle provided in the casing, since the insert only pivots between the two predefined positions.

### SUMMARY

To achieve a more reliable and less failure-prone quick release function, further improvement is desirable. Furthermore, there is a need for a pneumatic ABS device having such a quick release function that uses cost-efficient components.

To solve this object, the present disclosure provides that the quick release insert is configured to deform in the blocking position to sealingly rest against a sealing surface of the casing thereby blocking the flow path, and that the quick release insert returns into an undeformed basic position in an unloaded or low-loaded condition. Thus, blocking of the flow path is provided by the movement of the quick release insert in combination with a deformation resulting in a sealing blockage of the flow path. For deformation of the quick release insert, the pressurized air acting on the insert has to exceed a predefined value. As a result, an air flow provided at the working port being pressurized below the predefined value will not result in a deformation of the quick release insert. Thus, a slow release of the brake actuator via the supply port is also possible via the quick release insert. Furthermore, the present disclosure utilized the knowledge that a particularly simple and cost-efficient pneumatic ABS valve device can be achieved by providing a sealing blockage directly between the quick release insert and the casing without requiring additional parts as, for example, a separately formed insert chamber. In addition, by dispensing with additional parts, an undesired bypass between, for example, an insert chamber and the casing can be prevented.

Since the brake release insert returns due to its elasticity into its basic position in an unloaded or low-loaded condition, a repeatable and less failure prone quick release is provided. Thus, no external effects occurring during the lifetime of the vehicle can affect the quick release function. It will be understood that a low-loaded condition describes a condition in which a slow flow stream being pressurized under a predefined value is provided from the supply port either to the working port or in the reverse direction. Such a value may sufficiently deviate from the pressure values of the pressurized air provided during quick exhaust or the value needed for increasing the brake pressure, respectively.

Furthermore, it will be understood that the described movement of the quick release insert from its basic position into its blocking position and vice versa can be realized by a reversible bending movement such that the quick release insert bends in correspondence with the sealing surface without any linear movement and returns back into its basic position.

In a first embodiment of the present disclosure, the quick release insert allows a supply air flow from the supply port to the working port for increasing the pressure in the brake actuator in its basic position. Thus, contrary to common check valves, no initial pressure difference is necessary and the supply of pressurized air can start immediately after supplying pressure at the supply port.

The quick release insert typically comprises a rubber material at least on its surface and is preferably completely made of rubber or any other elastomeric material or mixtures thereof. Thus, the quick release insert has a low mass and is reliable and reversibly deformable.

Preferably, the quick release insert is configured to move into a flow position when a supply air flow is provided by the supply port, wherein the quick release insert is configured to deform in the flow position to rest against a rear part of the casing opposite to the sealing surface. It will be understood that a supply air flow describes the air flow provided for selectively increasing the pressure in the brake actuator. By suggesting that the quick release insert is further configured to move into a flow position in which the quick release insert rests against a rear part of the casing, the influence of the quick release insert on the air flow flowing through the flow path is reduced. Thus, the supply air flow is increased resulting in a quicker inflation of the brake actuator.

It is further preferred that the quick release insert is positioned in the casing in its basic position such that the air flow can bypass the quick release insert for a slow release of pressurized air from the working port to the supply port. Thus, a throttle for a slow release of pressurized air from the working port to the supply port is avoided.

Preferably, the quick release insert has at least a first free edge and an opposite second free edge and is freely positioned in the casing such that the first free edge and the second free edge are allowed to move back and forth towards the sealing surface. Thus, the quick release insert is more reliable and less wear exposed due to friction. Said movement may also include a linear component with respect to its center of gravity. It will be understood that the described movement also has a bending component, since the quick release insert deforms at least in the blocking position to sealingly rest against the sealing surface of the casing.

It is preferred that the edges remain in contact with the sealing surface in the basic position and in the blocking position. Thus, the quick release insert moves from the basic position into the blocking position by bending in correspondence with the sealing surface. Thereby a more reproducible movement into its basic position and exact arrangement of the quick release insert can be achieved.

It is preferred, that the casing has a first rib and a second rib arranged at a distance from each other and extending from the sealing surface towards the rear part, thereby defining an insert chamber between them in which the quick release insert is received such that a movement back and forth towards the sealing surface is enabled, and any movement in the perpendicular direction is at least restricted. In particular, the movement is restricted in the transversal direction. Thus, when the quick release insert is in the basic position or in the blocking position, the first rib extends adjacent to the first free edge and the second rib extends adjacent to the second free edge. By providing an insert chamber for receiving the quick release insert and restricting its movement, an undesired displacement of the quick release insert is securely avoided.

In a preferred embodiment, the quick release insert is formed as a flat piece having a thickness, wherein the ratio of the thickness to the stiffness is chosen such that the quick release insert is deformable upon the exhaust air flow in correspondence with the sealing surface of the casing surrounding the passage. Thus, the quick release insert is easy to manufacture and cost-effective. Furthermore, the simple geometry allows an exact calculation of the bending behavior of the quick release insert. As such, the thickness of the quick release insert can be chosen in correspondence to the bending behavior thereby allowing an appropriate bending stiffness and material saving design at the same time.

It is preferred that the thickness of the quick release insert is in a range from 0.9 to 1.1 mm and preferably has a hardness in a range from 70 to 80 IRHD (i.e., when the hardness is measured using International Rubber Hardness Degree). Thus, an appropriate stiffness is provided and at the same time, the quick release insert is easy to handle during manufacturing.

It is further preferred that the quick release insert is arranged adjacent to the supply port. Thus, the blocking of the flow path is realized directly at the supply port, i.e. not downstream from a solenoid valve. This ensures that a rapid air blocking does not cause resonance effects inside the ABS valve device.

In a preferred embodiment, the flow path is partly defined by a passage extending from the sealing surface towards the supply port, wherein the quick release insert blocks the passage by resting against the sealing surface. Since the quick release insert rests against the sealing surface surrounding the passage, a limited displacement of the quick release insert does not affect an appropriate blocking of the passage. It has to be understood, that the size of the quick release insert has to be chosen, such that an appropriate area overlapping the passage is provided to avoid an undesired displacement of the quick release insert to the inside of the passage.

Preferably, the quick release insert overlaps the passage such that the quick release insert exceeds the cross section of the passage in all directions. Thus, a less failure-prone quick release function is provided.

It is preferred that the casing is at least partly formed of an injection moldable polymer. Thus, a lightweight and cost-efficient casing is provided. Further, the polymer casing provides a low friction resulting in a reduced wear of the quick release insert moving at least between the basic position and the blocking position within the casing.

Preferably, the casing is injection molded. Thus, a high degree of function integration is allowed while providing reasonable manufacturing cost.

In a further embodiment, the quick release insert has a rear surface facing the rear part of the casing, and the rear part includes a support structure protruding from the rear part and being configured to support a portion of the rear surface of the quick release insert. By supporting the quick release insert by a protruding support structure, the remaining part of the rear surface of the quick release insert is free to be advanced by pressurized air in order to move the quick release insert into the blocking position. Preferably, the support structure equally supports the rear surface of the quick release insert such that the remaining rear surface provides equally advancing the quick release insert towards the sealing surface by the exhaust air flow.

It is preferred that the support structure is integrally formed with the casing. Thus, the support structure is easy to manufacture, i.e. by injection molding. Thereby, the number of parts to manufacture can be reduced and thus the manufacturing costs are decreased.

It is further preferred that the support structure has a first protrusion and at least a second protrusion arranged at a distance to the first protrusion, the first protrusion being configured for supporting the rear surface at a first section and the second protrusion being configured for supporting the rear surface at a second section. Thus, a more equal support of the rear surface is provided.

However, it should be understood that also two or more protrusions can be provided to support the rear surface of the quick release insert. The number of protrusions depends on the size of the quick release insert and the space provided within the casing.

Preferably, the supported portion of the rear surface of the quick release insert is from ½ to ⅔ of the surface area of the rear surface. By having a supported portion in the suggested range, an appropriate support of the quick release insert is provided and at the same time the quick release insert can quickly move upon an exhaust air flow into the blocking position.

In a further preferred embodiment, the support structure has a T-shaped cross section providing an enlarged supporting surface facing towards the rear surface of the quick release insert. By having such a T-shaped cross section, a lightweight and material-saving support structure is provided.

It is preferred that the support structure provides a convex supporting surface facing towards the rear surface of the quick release insert. By having a convex supporting surface, the quick release insert can bend along the convex shape, wherein sharp edges are avoided that could affect the reliability of the quick release insert.

According to a second aspect of the present disclosure, the above stated problem is solved by a vehicle, in particular commercial vehicle, comprising: a pneumatic ABS valve device according to the first aspect; a pneumatic brake system having a brake actuator connected to the working port of the pneumatic ABS valve device; and a pneumatic brake line connected to the supply port for supplying pressurized air. It should be understood that the vehicle according to the second aspect of the present disclosure and the pneumatic ABS valve device according to the first aspect of the present disclosure preferably have similar of equal aspects, in particular as they are described herein. Thus, reference is made to the above description of the pneumatic ABS valve device according to the first aspect of the present disclosure.

According to a third aspect of the present disclosure, the above stated problem is solved by a method for quick releasing pressurized air from a pneumatic brake, the method comprising the steps of: providing a pneumatic ABS valve device according to the first aspect of the present disclosure and a pneumatic brake system having a brake actuator, wherein the brake actuator is connected to the working port of the pneumatic ABS valve device; providing an exhaust air flow from the brake actuator by the working port; moving the quick release insert into a blocking position by the exhaust air flow; blocking the flow path by the quick release insert resting against a sealing surface of the casing; releasing the exhaust air from the brake actuator at the exhaust port; and returning the insert into an undeformed basic position in an unloaded or low-loaded condition. It should be understood that the method according to the third aspect of the present disclosure having a first step in which the pneumatic ABS valve device according to the first aspect of the present disclosure is provided have similar of equal aspects, in particular as they are described herein. Thus, reference is made to the above description of the pneumatic ABS valve device according to the first aspect of the present disclosure.

For a more complete understanding of the present disclosure, the present disclosure will now be described in detail with reference to the accompanying drawings. The detailed description will illustrate and describe what is considered as a preferred embodiment of the present disclosure. It should of course be understood that various modifications and changes in form or detail could readily be made without departing from the spirit of the present disclosure. It is therefore intended that the present disclosure may not be limited to the exact form and detail shown and described herein, nor to anything less than the whole of the present disclosure disclosed herein and as claimed herein after. Further, the features described in the description, the drawings and the claims disclosing the present disclosure may be essential for the present disclosure considered alone or in combination. In particular, any reference signs in the claims shall not be construed as limiting the scope of the present disclosure. The wording “comprising” does not exclude other elements or steps. The word “a” or “an” does not exclude the plurality. The wording “a number of” items comprising also the number 1, i.e. a single item, and further numbers like 2, 3, 4 and so forth.

### BRIEF DESCRIPTION OF THE DRAWINGS

In the accompanying drawings:

FIG. 1 shows a sectional view of a pneumatic ABS solenoid valve device according to an embodiment of the present disclosure;

FIG. 2 shows a block diagram of an embodiment of a vehicle having the pneumatic ABS solenoid valve device according to the present disclosure;

FIG. 3 shows a top view of the pneumatic ABS solenoid valve device according to FIG. 1;

FIG. 4 shows a top view according to FIG. 3 with the quick release insert being removed;

FIG. 5 shows an enlarged perspective view of the casing of the pneumatic ABS solenoid valve device according to FIG. 1;

FIG. 6 shows an enlarged perspective view according to FIG. 5 with the quick release insert being removed;

FIG. 7 shows a sectional view, more particularly a cross-sectional view of at least a portion of the pneumatic ABS solenoid valve device according to FIG. 1 with the quick release insert being in position A;

FIG. 8 shows a sectional view, more particularly a cross-sectional view of at least a portion of the pneumatic ABS solenoid valve device according to FIG. 1 with the quick release insert being in position B; and

FIG. 9 shows a sectional view, more particularly a cross-sectional view of at least a portion of the pneumatic ABS solenoid valve device according to FIG. 1 with the quick release insert being in position C.

### DETAILED DESCRIPTION

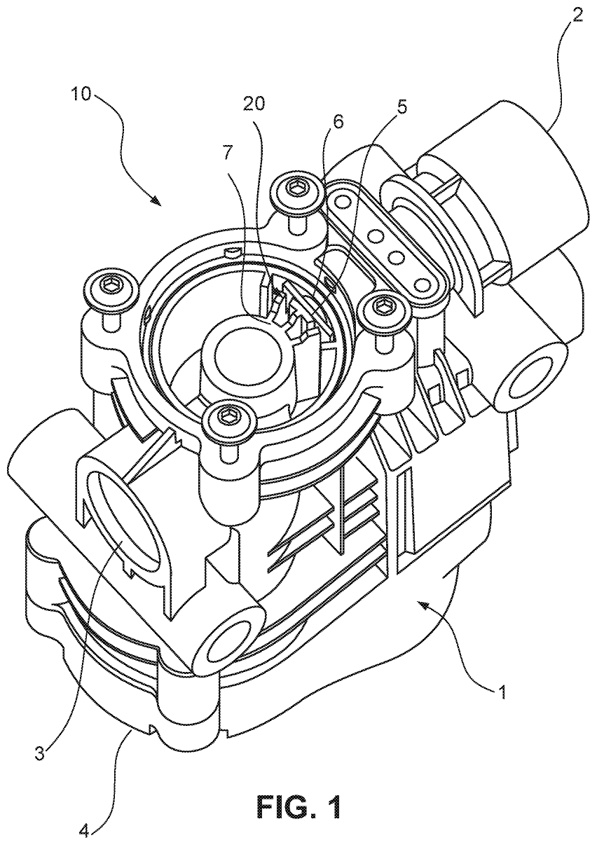

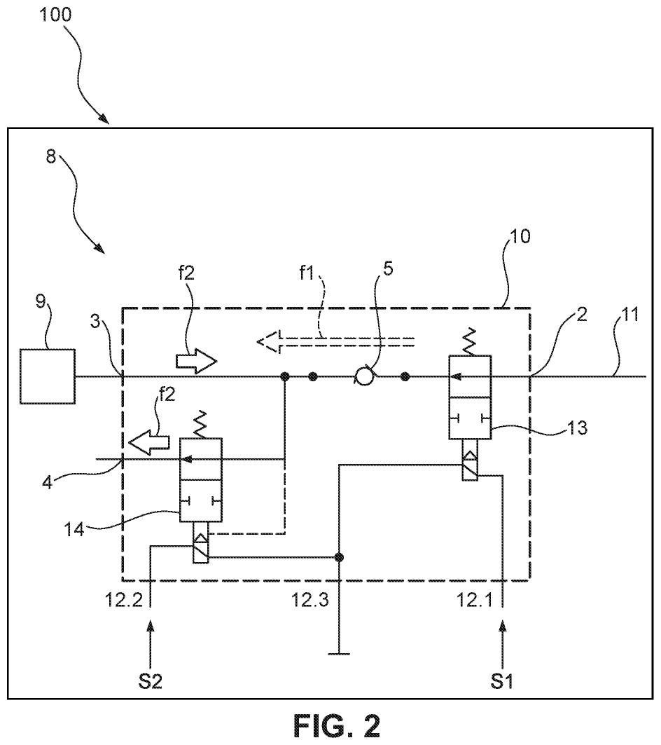

A pneumatic ABS solenoid valve 10 is depicted in FIG. 1. The pneumatic ABS solenoid valve 10 includes a casing 1, having a supply port 2 for supplying pressurized air, a working port 3 for delivering pressurized air to a pneumatic brake actuator 9 (see FIG. 2), and an exhaust port 4 for a quick release of pressurized air from a respective brake actuator 9 (see FIG. 2).

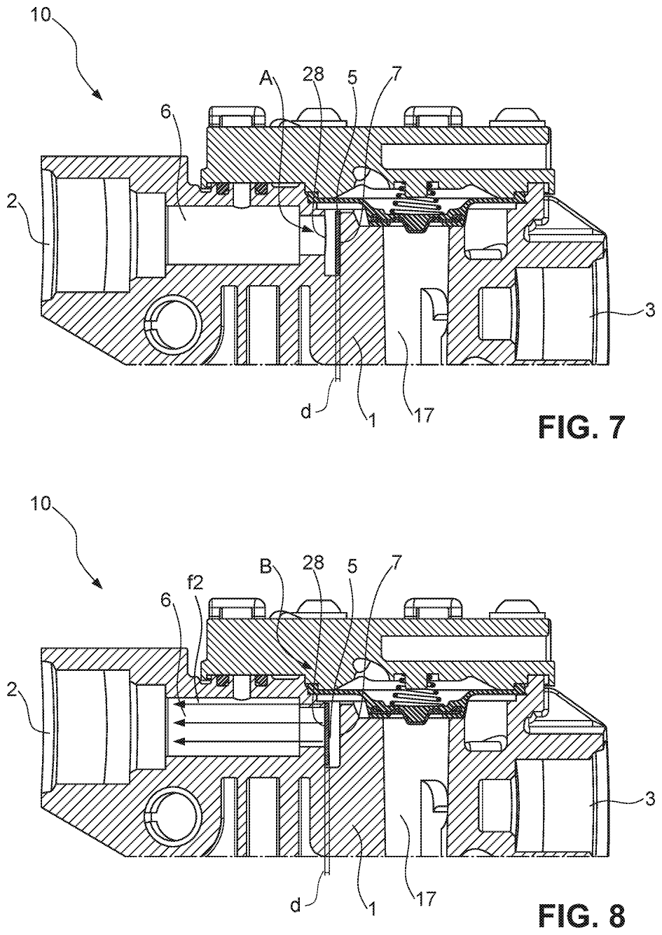

The pneumatic ABS solenoid valve 10 further includes a quick release insert 5, which is received within the casing 1, and which is freely positioned in the casing 1 such that a movement in at least two, preferable all three spatial directions is allowed. The quick release insert 5 is formed as a flat piece having a thickness ‘d’ (see FIGS. 7-9).

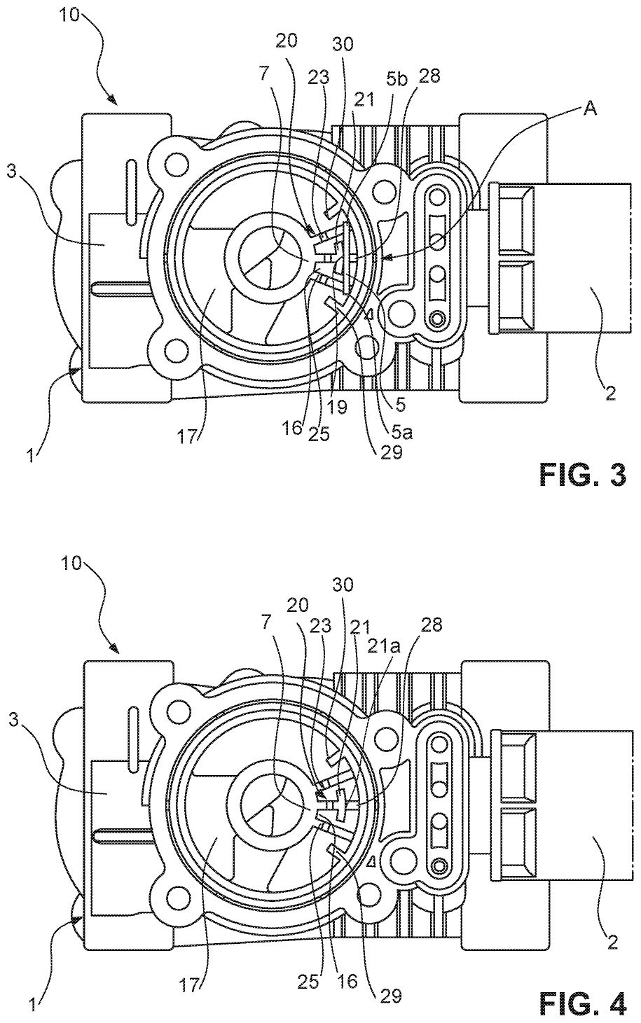

The casing 1 has a passage 6 provided in the casing 1 and extending to the supply port 2. The casing 1 further has a rear part 7 configured to support a rear surface 19 of the quick release insert 5 facing away from the passage 6. In the casing 1, a flow path 17 (see FIGS. 3 and 4) is provided between the supply port 2 and the working port 3 which is partly defined by the passage 6.

The quick release insert 5 is at least partly arranged or positioned in the flow path 17 adjacent to the supply port 2. It is preferred that quick release insert 5 is arranged between the rear part 7 and the entrance of the passage 6.

As mentioned in the previous paragraph, the quick release insert 5 is at least partly arranged or positioned in the flow path 17 such that when the quick release insert 5 blocks the passage 6, air flow from the working port 3 to the supply port 2 is avoided or preferably, blocked. Instead, the exhaust air flow provided at the working port 3 will flow through an internal exhaust passage (not shown in FIG. 1) extending between the working port 3 and the exhaust port 4.

The exhaust port 4 is configured for releasing the pressurized air from the brake actuator 9 (see FIG. 2) provided by the brake actuator 9 via the working port 3.

The block diagram of FIG. 2 depicts a vehicle 100, in particular a commercial vehicle, having a brake system 8 including a brake actuator 9 and a pneumatic ABS valve device 10.

The pneumatic ABS valve device 10 includes a supply port 2 for receiving pressurized air from a pressure source and supplying pressurized air to the valve device 10, working port 3 for delivering pressurized air to a pneumatic brake system 8, in particular brake actuator 9, and exhaust port 4 for a quick release or quick exhausting of pressurized air from the brake actuator 9.

According to the block diagram of FIG. 2, the brake actuator 9 is connected to the working port 3, the supply port 2 is connected to a pneumatic brake line 11 extending from a compressed air source via e.g. a control valve or from a pressurized air tank. The pneumatic ABS valve device 10 of FIG. 2 further includes electric control inputs 12.1. 12.2 and 12.3, wherein the electric control input 12.3 is a ground line input connection to ground, the electric control input 12.1 is a first control input for receiving first electric control signal S1 and the electric control input 12.2 is a second control input for receiving a second electric control signal S2.

A first 2/2 solenoid blocking valve 13 is connected to or positioned at the supply port 2 and electrically/electronically controlled by a first electric signal S1. A quick release insert 5 may be arranged between the first 2/2 solenoid blocking valve 13 and the working port 3. A second 2/2 solenoid blocking valve 14, whose position is switched for connecting a downstream end of quick release insert 5 with either the working port 3 or the exhaust port 4, wherein the second blocking valve 14 is controlled by a second electric signal S2.

In their flow position, both 2/2 solenoid blocking valves 13, 14 may be open respectively.

The first 2/2 solenoid blocking valve 13 is provided for selectively supplying pressure from the supply port 2 via a flow path 17 or a passage 6 (see FIGS. 3 to 9) and alongside the quick release insert 5 to the working port 3 for actuating the brake actuator 9. The first 2/2 solenoid blocking valve 13 is switchable from a flow position in which a signal S1=0 is provided to a blocking position by providing a signal S1=1. The second 2/2 solenoid blocking valve 14 is provided for selectively connecting the working port 3 to the exhaust port 4. The second 2/2 solenoid blocking valve 14 is switchable from a flow position in which a signal S2=0 is provided to a blocking position by providing a signal S2=1.

In a first condition, when the signals S1=0 and S2=1 are provided, the pneumatic ABS valve device 10 enables a pressure supply from the supply port 2 via the passage 6 (see FIG. 1) and alongside a quick release insert 5 to the working port 3 for actuating the brake actuator 9, as indicated by an supply air flow f1. Further, in accordance with an exemplary embodiment, a slow release of pressurized air (e.g., in minimal or negligible amount) from the brake actuator 9 may be enabled in the first condition by i.e. an air flow in the reverse direction from the working port 3 to the supply port 2 via a throttle provided by the insert 5 in its basic position A (see FIG. 7), in which the reverse air flow is limited, but still enabled.

The pneumatic brake line 11 may be connected to a control relay valve (not shown in FIG. 2), which can be switched for pressurizing or venting the pneumatic brake line 11. It is the function of pressure supply port 2, i.e. for braking action or “slow pressure release” (see e.g., the above paragraph), to control the external control relay valve connected to the pneumatic brake line 11 without actuating the first and second 2/2 solenoid blocking valves 13, 14.

In a second condition, when the electric control signals S1=1 and S2=0 are provided, a quick release of pressurized air from the brake actuator 9 via the working port 3 to the exhaust port 4 is enabled, as indicated by an exhaust air flow f2. In the first condition, air can flow directly in the open first 2/2 solenoid blocking valve 13 and through the passage 6, which is not blocked in this direction by the quick release insert 5, to the working port 3.

For the quick release of the pressurized air in the brake actuator 9, the air supply from the supply port 2 is cut off by providing the electric control signal S1=1 to switch the first 2/2 solenoid blocking valve 13 into its blocking position and the signal S2=0 to switch the second 2/2 solenoid blocking valve 14 is into its flow position. In these positions, the first and second 2/2 solenoid blocking valves 13, 14 enable bleeding the air via the working port 3 through the second 2/2 solenoid blocking valve 14 to the exhaust port 4. The quick release mode realized within the ABS solenoid valve device 10 and the function of the quick release insert 5 can best be seen in FIGS. 3, 5 and 7 to 9.

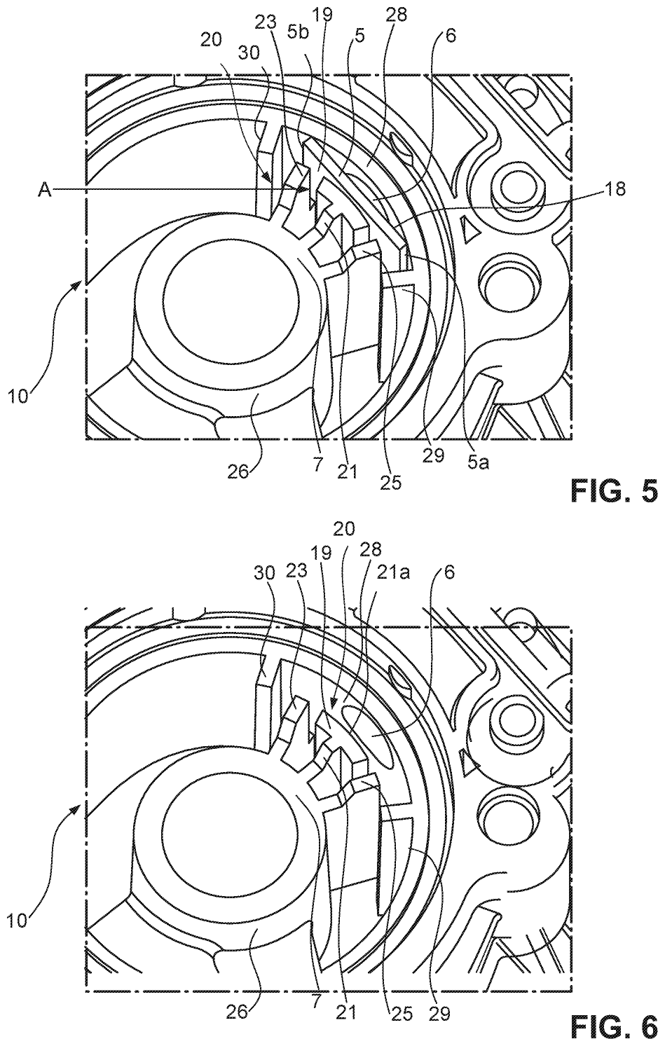

FIGS. 3 and 5 show the casing 1 with the quick release insert 5 in the basic position A. The quick release insert 5 may be received within an insert chamber 16 being provided in the casing 1. The insert chamber 16 is integrally formed with the casing 1. In the basic position, the quick release insert 5 partly rests against a rear part 7. The quick release insert 5 has a first edge 5a and a second edge 5b (see FIGS. 3 and 5) that can freely move back and forth towards the sealing surface 28.

As depicted in FIGS. 3 and 4, the flow path 17 is provided between the supply port 2 and the working port 3, wherein the flow path 17 is partly defined by the passage 6. The flow path 17 has a first flow path and a second flow path which are connected to the working port 3 and the exhaust port 4 (see FIG. 1), respectively.

The quick release insert 5 has a rear surface 19 (see FIG. 3) resting against the rear part 7.

The casing 1 has a support structure 20 protruding from the rear part 7. The support structure 20 comprises a first protrusion 21, a second protrusion 23, and a third protrusion 25. It will be understood that the support structure 20 can be defined by any number of protrusions or by a single protrusion.

The first protrusion 21 has a T-shaped cross section providing an enlarged contact surface 21a to the rear surface 19 of the quick release insert 5, as shown in FIG. 4. The first protrusion 21 provides a central support for the quick release insert 5, while the second protrusion 23 and the third protrusion 25 provide an additional support of the edges 5a, 5b (see FIGS. 3 and 5) of the quick release insert 5. Preferably, the quick release insert 5 is in contact with the first protrusion 21 in its basic position A, as shown in FIG. 5. Preferably, the quick release insert 5 may be in contact with the first protrusion 21 (refer e.g., FIG. 3 for the location of first protrusion 21) in its flow position C, as shown in FIG. 9. In the flow position C, the quick release insert 5 may be bent around the concave contact surface 21a of the first protrusion 21.

The first protrusion 21, the second protrusion 23 and the third protrusion 25 are angularly offset from and arranged at a distance from each other, such that pressurized air is allowed to advance the rear surface 19 of the quick release insert 5.

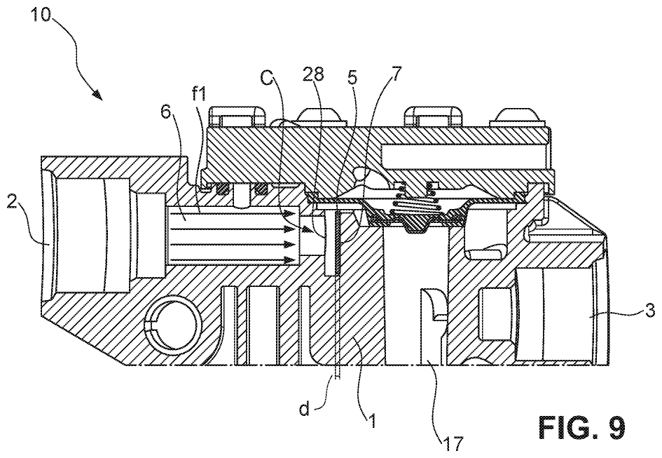

The casing 1 has a sealing surface 28 opposite to an annular surface 26 (see FIGS. 5 and 6) and the rear part 7. The sealing surface 28 surrounds the entrance of the passage 6, as shown in FIG. 6, and thus forms a valve seat for the quick release insert 5. In the blocking position B (see FIG. 8), the quick release insert 5 deforms to sealingly rest against the sealing surface 28.

The sealing surface 28 is preferably concave with respect to the quick release insert 5 such that the quick release insert 5 needs to deform in correspondence to the sealing surface 28 in order to sealingly block the passage 6.

The casing 1 further has a first rib 29 and a second rib 30, which extends from the sealing surface 28 towards the rear part 7 and the annular surface 26, respectively.

The insert chamber 16 is defined by the ribs 29, 30, annual surface 26 of the rear part 7 and the sealing surface 28. As such, the quick release insert 5 received in the insert chamber 16 is allowed to move back and forth towards the sealing surface 28 but limited in its lateral movement i.e., in the perpendicular direction by the ribs 29, 30. Thus, an undesired displacement of the quick release insert 5 into a position outside the insert chamber 16 is avoided.

It is preferred that the edges 5a, 5b remain in contact with the concave sealing surface 28 in the basic position A and in the blocking position B. Thus, the quick release insert 5 moves from the basic position A into the blocking position B by bending in correspondence with the sealing surface 28. Thereby a more reproducible movement into its basic position A and exact arrangement of the quick release insert 5 is provided.

FIGS. 7 to 9 show the casing 1 with the quick release insert 5 being in different positions.

FIG. 7 shows the quick release insert 5 in its basic position A. In the basic position A, the quick release insert 5 rests at least partly against the rear part 7 having the protruding support structure 20 (c.f. FIG. 6) defined by the first protrusion 21, the second protrusion 23, and the third protrusion 25.

In the basic position A, a slow release from the working port 3 to the supply port 2 is enabled, since the pressurized air can bypass the quick release insert 5 and flow through the passage 6 of the flow path 17.

FIG. 8 shows the quick release insert 5 in the blocking position B. The quick release insert 5 is movable from the basic position A as indicated in FIG. 7 into the blocking position B by an exhaust air flow f2 provided by the brake actuator 9 via the working port 3 (see FIG. 2). The exhaust air flow f2 urges the quick release insert 5 to move towards the sealing surface 28 of the casing 1. Due to a reversible deformation of the quick release insert 5, the passage 6 is sealingly blocked. From the blocking position B, the quick release insert 5 returns into the basic position A, when the exhaust air flow f2 has been released via the exhaust port 4.

FIG. 9 shows the quick release insert 5 received in the casing 1 in a preferred flow position C. In the flow position C, a supply air flow f1 is provided at the supply port 2 (see FIG. 2) to urge the quick release insert 5 from the basic position A, as indicated in FIG. 7. In said flow position C the quick release insert 5 sealingly rests against the support structure 20 defined by the protrusions 21, 23, 25. In the flow position C, the quick release insert 5 is preferably bent in accordance with the shape of the protrusions 21, 23, 25. Thus, the influence of the quick release insert 5 on the pressurized air flowing through the flow path 17 is decreased.

In summary, for quick release of pressurized air from a pneumatic brake actuator 9 via a pneumatic ABS valve device 10 according to the present disclosure, an exhaust air flow f2 from the brake actuator 9 (see FIG. 2) is provided by the working port 3. Next, the quick release insert 5 is moved into the blocking position B (see FIG. 8) by the exhaust air flow f2. In the blocking position B, the flow path 17 and the passage 6 are blocked by the quick release insert 5 resting against the sealing surface 28.

When the quick release insert 5 blocks the flow path 17 between the supply port 2 and the working port 3, the exhaust air flow is released from the working port 3 via a second flow path to the exhaust port 4. After the exhaust air flow is released from the exhaust port 4, the pneumatic ABS valve device 10 is in an unloaded or low-loaded condition and the quick release insert 5 returns back into an undeformed basic position A.

### LIST OF REFERENCE SIGNS (PART OF THE SPECIFICATION)

1 casing
2 supply port
3 working port
4 exhaust port
5 quick release insert
5a first free edge
5b second free edge
6 passage
7 rear part
8 pneumatic brake system
9 pneumatic brake actuator
10 pneumatic ABS valve device
11 pneumatic brake line
12.1 first control input
12.2 second control input
12.3 ground line input
13 first 2/2 solenoid blocking valve
14 2/2 solenoid blocking valve
16 insert chamber
17 flow path
19 rear surface
20 support structure
21 first protrusion
21a contact surface
23 second protrusion
25 third protrusion
26 annular surface
28 sealing surface
29 first rib
30 second rib
100 vehicle
A basic position
B blocking position
C flow position
f1 supply air flow
f2 exhaust air flow
S1 first electric control signal
S2 second electric control signal
d thickness of the quick release insert

What is claimed is:

1. A pneumatic ABS valve device (10) for a pneumatic brake system (8) of a vehicle (100), the pneumatic ABS valve device (10) comprising:
a casing (1) configured for fluid connection to a pneumatic brake, the casing (1) comprising:
a supply port (2) for receiving pressurized air;
a working port (3) for providing a braking pressure to a brake actuator (9);
an exhaust port (4) for a releasing pressurized air from the brake actuator (9); and
a flow path (17) defined in the casing (1) and connecting the working port (3) and the supply port (2);
a quick release insert (5) being reversibly deformable and at least partly arranged in the flow path (17),
wherein the quick release insert (5) is moveably received in the casing (1) and moves into a blocking position (B) when an exhaust air flow (f2) is provided by the working port (3),
wherein the quick release insert (5) is deformed in the blocking position (B) and sealingly rests against a sealing surface (28) of the casing (1) thereby blocking the flow path (17), and
wherein the quick release insert (5) returns into an undeformed basic position (A) in an unloaded or low-loaded condition.

2. The pneumatic ABS valve device (10) according to claim 1,
wherein the quick release insert (5) moves into a flow position (C) when a supply air flow (f1) is provided by the supply port (2), and
wherein the quick release is deformed in the flow position (C) and rests against a rear part (7) of the casing (1) opposite to the sealing surface (28).

3. The pneumatic ABS valve device (10) according to claim 1,
wherein the quick release insert (5) has at least a first free edge (5a) and an opposite second free edge (5b) and is freely positioned in the casing (1) such that the first free edge (5a) and the second free edge (5b) are enabled to move back and forth towards the sealing surface (28) and away from the sealing surface (28).

4. The pneumatic ABS valve device (10) according to claim 2,
wherein the casing (1) has a first rib (29) and a second rib (30) arranged at a distance from each other and extending from the sealing surface (28) towards the rear part (7), thereby defining an insert chamber (16) between them in which the quick release insert (5) is received such that a movement back and forth towards and away from the sealing surface (28) is enabled, and movement side-to-side between the first rib and the second rib is at least restricted.

5. The pneumatic ABS valve device (10) according to claim 1,
wherein the quick release insert (5) is positioned in the casing (1) in its basic position (A) such that the air flow can bypass the quick release insert (5) for a release of pressurized air from the working port (3) to the supply port (2).

6. The pneumatic ABS valve device (10) according to claim 1,
wherein the quick release insert (5) is formed as a flat piece having a thickness (d), wherein the ratio of the thickness (d) to the stiffness is chosen such that the quick release insert (5) is deformable to correspond to the sealing surface (28) of the casing (1) surrounding the passage (6) in response to the exhaust air flow (f2).

7. The pneumatic ABS valve device (10) according to claim 1,
wherein the quick release insert (5) is arranged adjacent to the supply port (2).

8. The pneumatic ABS valve device (10) according to claim 1,
wherein the flow path (17) is partly defined by a passage (6) extending from the sealing surface (28) towards the supply port (2), and wherein the quick release insert (5) blocks the passage (6) by resting against the sealing surface (28).

9. The pneumatic ABS valve device (10) according to claim 1,
wherein the casing (1) is at least partly formed of an injection moldable polymer.

10. The pneumatic ABS valve device (10) according to claim 2,
wherein the quick release insert (5) has a rear surface (19) facing the rear part (7) of the casing (1), and the rear part (7) includes a protruding support structure (20) that supports a portion of the rear surface (19) of the quick release insert (5).

11. The pneumatic ABS valve device (10) according to claim 10,
wherein the support structure (20) is integrally formed with the casing (1).

12. The pneumatic ABS valve device (10) according to claim 10,
wherein the support structure (20) has a first protrusion (21) and at least a second protrusion (23) arranged at a distance to the first protrusion (21), the first protrusion (21) supporting a first section of the rear surface (19) and the second protrusion (23) supporting a second section of the rear surface (19).

13. The pneumatic ABS valve device (10) according to claim 10 any one of the claims 10 to 12,
wherein the supported portion of the rear surface (19) includes ½ to ⅔ of a surface area of the rear surface (19).

14. The pneumatic ABS valve device (10) according to claim 10,
wherein the support structure (20) has a T-shaped cross section providing an enlarged supporting surface facing towards the rear surface (19) of the quick release insert (5).

15. The pneumatic ABS valve device (10) according to claim 10,
wherein the support structure (20) provides a convex supporting surface facing towards the rear surface (19) of the quick release insert (5).

16. A vehicle (100) comprising:
a pneumatic ABS valve device (10) according to claim 1;
a pneumatic brake system (8) having a brake actuator (9) connected to the working port (3) of the pneumatic ABS valve device (10); and
a pneumatic brake line (11) connected to the supply port (2) for supplying pressurized air.

17. A method for quick releasing pressurized air from a pneumatic brake system (8), the method comprising the steps of:
providing a pneumatic ABS valve device (10) according to claim 1 and a pneumatic brake system (8) having a brake actuator (9), wherein the brake actuator (9) is connected to the working port (3) of the pneumatic ABS valve device (10);
providing an exhaust air flow (f2) from the brake actuator (9) through the working port (3) into the valve device (10);
moving the quick release insert (5) into a blocking position (B) in response to providing the exhaust air flow (f2);
blocking the flow path (17) by resting the quick release insert (5) against a sealing surface (28) of the casing (1);
releasing exhaust air from the brake actuator (9) through the exhaust port (4); and
returning the insert (5) into an undeformed basic position (A) in an unloaded or low-loaded condition after releasing the exhaust air.

18. The pneumatic ABS valve device (10) according to claim 1,
wherein the flow path (17) includes a first part connecting the supply port (2) and the working port (3) and a second part connecting the working port (3) and the exhaust port (4).

19. The pneumatic ABS valve device (10) according to claim 18,
wherein the insert deforms and blocks the first part of the flow path when the exhaust pressure exceeds a predetermined level, such that exhaust air flows between the working port and the exhaust port via the second part of the flow path.

20. The pneumatic ABS valve device (10) according to claim 18,
wherein the insert returns to its undeformed basic position when the exhaust air is below the predetermined level, such that the first part of the flow path is open between the working port and the supply port, wherein the first part remains open when supply pressure is provided from the supply port.
